(19) United States
(12) Patent Application Publication
(10) Pub. No.: US 2026/0149563 A1
(43) Pub. Date: May 28, 2026

(54) HOMOMORPHIC ENCRYPTION

(71) Applicant: INAIT SA, Lausanne (CH)

(72) Inventors: Henry Markram, Lausanne (CH); Felix Schuermann, Grens (CH); Kathryn Hess Bellwald, Aigle (CH); Fabien Delalondre, Geneva (CH)

(21) Appl. No.: 19/370,999

(22) Filed: Oct. 28, 2025

Related U.S. Application Data
(63) Continuation of application No. 18/295,959, filed on Apr. 5, 2023, now Pat. No. 12,476,787.
Application No. 18/295,959 is a continuation of application No. 16/356,391, filed on Mar. 18, 2019, now Pat. No. 11,652,603.

(51) Int. Cl. H04L 9/00; G06F 17/18; G06F 21/60; G06N 3/047

(52) U.S. Cl. CPC H04L 9/008; G06F 17/18; G06F 21/602; G06N 3/047

(57) ABSTRACT

Methods, systems, and devices for homomorphic encryption. In one implementation, the methods include inputting first data into a recurrent artificial neural network, identifying patterns of activity in the recurrent artificial neural network that are responsive to the input of the secure data, storing second data representing whether the identified patterns of activity comports with topological patterns, and statistically analyzing the second data to draw conclusions about the first data.

### CROSS-REFERENCE TO RELATED APPLICATIONS

This application is a continuation of U.S. application Ser. No. 18/295,959, filed Apr. 5, 2023, now allowed, which is a continuation of U.S. application Ser. No. 16/356,391, filed Mar. 18, 2019, now U.S. Pat. No. 11,652,603, the contents of both of which are hereby incorporated by reference in its entirety.

### BACKGROUND

Cryptographic encryption provides secure communications between a parties even in the event that a third party (commonly called an “adversary”) intercepts the communication. Encrypted communications are encoded such that only authorized recipient(s) can access the communications. In general, the communications themselves are referred to as “plaintext,” which is a term that encompasses both textual and other messages. The algorithm that encrypts the communications is commonly referred to as a “cipher” and the encrypted communications are referred to as “ciphertext.” Although the ciphertext may be intercepted or otherwise available to an adversary, decoding the ciphertext to access the encrypted communication is generally very difficult.

In general, encryption can be classified as “symmetric key” or “public key.” In symmetric key encryption, the same key is used for encrypting plaintext and decrypting ciphertext. Since both the sending and receiving parties must have access to the same symmetric key, the symmetric key must be exchanged over a secure channel to ensure. In public key encryption, the encryption key can be published and used by many parties to encrypt plaintext. However, only the intended recipients should have access to the decryption key that enables ciphertext to be decrypting.

In some instances, a party need not fully decrypt a ciphertext in order to use the ciphertext in computations. In so-called “homomorphic encryption,” operations performed on ciphertexts can yield results that, when decrypted, match the results of comparable operations performed on the corresponding plaintext. Examples of operations include linear and non-linear statistical analysis, as well as deep learning and other AI-based techniques.

Homomorphic encryption is particularly useful in contexts where computations are performed by parties who are not to have unrestricted access to the plaintext. For example, a party who is doing statistical analyses on medical data may not be entitled to access patient-identifying information. However, the results of the analysis should be as accurate as if the party had access to full identifying information.

### SUMMARY

This document relates to homomorphic encryption, and to systems and techniques that perform homomorphic encryption. For example, in one implementation, a homomorphic encryption method includes storing binary data, wherein each digit in the binary data represents whether activity in a recurrent artificial neural network comports with a respective pattern, wherein the activity is responsive to an input of secure data, and statistically analyzing the binary data to draw conclusions about the secure data. The method can be implemented in hardware, in software, or in a combination thereof.

This and other homomorphic encryption methods can include one or more of the following features. The patterns of activity in the recurrent artificial neural network can include simplex patterns of activity in the network, for example, wherein the simplex patterns are directed simplices or wherein the simplex patterns enclose cavities. The method can include identifying the patterns of activity in the recurrent artificial neural network. Identifying the patterns of activity can include determining a timing of activity having a complexity that is distinguishable from other activity that is responsive to the input, and identifying the patterns based on the timing of the activity that has the distinguishable complexity. The method can include receiving data characterizing tailoring a characteristic of inputting of the secure data into the network, and tailoring the inputting of the plaintext into the network in accordance with the data. The data can characterize either synapses and nodes into which bits of the plaintext are to be injected, or an order in which bits of the plaintext are to be injected. The method can also include tailoring the response of the network to the input of the secure data, for example, by creating or removing a node or a link within the network or by changing one or more properties of a node or a link within the network.

In another implementation, a homomorphic encryption method includes inputting first data into a recurrent artificial neural network, identifying patterns of activity in the recurrent artificial neural network that are responsive to the input of the secure data, storing second data representing whether the identified patterns of activity comports with topological patterns, and statistically analyzing the second data to draw conclusions about the first data. The method can be implemented in hardware, in software, or in a combination thereof.

This and other homomorphic encryption methods can include one or more of the following features. The patterns of activity in the recurrent artificial neural network can include simplex patterns of activity in the network, for example, wherein the simplex patterns are directed simplices or wherein the simplex patterns enclose cavities. Identifying the patterns of activity can include determining a timing of activity having a complexity that is distinguishable from other activity that is responsive to the input, and identifying the patterns based on the timing of the activity that has the distinguishable complexity. The method can include receiving data characterizing tailoring a characteristic of inputting of the secure data into the network, and tailoring the inputting of the plaintext into the network in accordance with the data. The data can characterize either synapses and nodes into which bits of the plaintext are to be injected, or an order in which bits of the plaintext are to be injected. The method can include tailoring the response of the network to the input of the secure data, for example, by creating or removing a node or a link within the network or by changing one or more properties of a node or a link within the network.

In some implementations, a non-transitory computer-readable storage medium can have instructions stored thereon that, when executed by one or more processors, cause the one or more processors to perform any of the homomorphic encryption methods described above.

In some implementations, a homomorphic encryption device can be configured to perform any of the homomorphic encryption methods described above.

The details of one or more embodiments are set forth in the accompanying drawings and the description below. Other features, objects, and advantages will be apparent from the description and drawings, and from the claims.

### DESCRIPTION OF THE DRAWINGS

FIG. 1 is a schematic representation of a process for homomorphic encryption of data.

FIGS. 2 and 3 are representations of patterns of activity that can be identified and read in a recurrent artificial neural network.

FIG. 4 is a schematic representation of a determination of the timing of activity patterns that have a distinguishable complexity.

### DETAILED DESCRIPTION

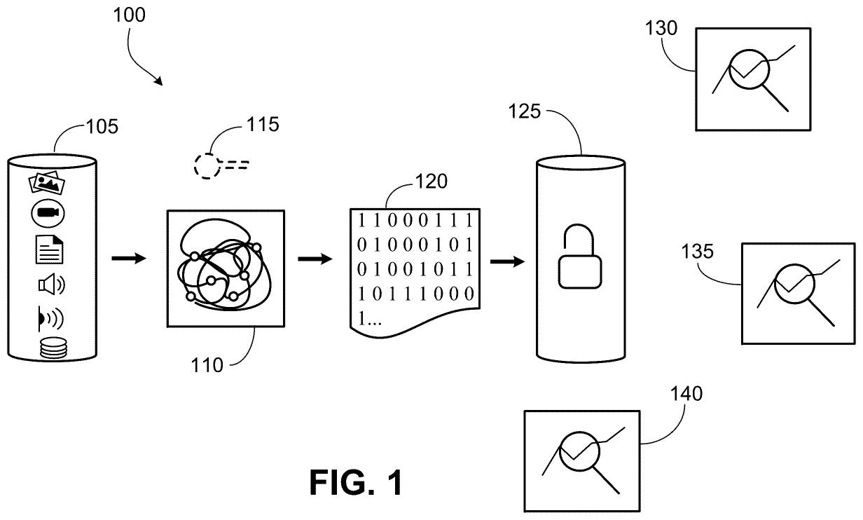

FIG. 1 is a schematic representation of a process 100 for homomorphic encryption of data. Process 100 can be performed by one or more computing devices, either autonomously or under the operational oversight of a human.

In process 100, a collection of data has been stored in one or more data storage devices 105. As illustrated, the stored data can include, e.g., image data, video data, text data, audio data, and/or structured or unstructured database data. In some cases, data storage devices 105 can form a data center of a corporate or other entity. The entity or entities who own the data stored on data storage devices 105 may, for one or more reasons, wish to limit access to the data by others. For example, the stored data may include trade secrets or other data of commercial importance to the owner(s). As another example, access to the data may be regulated by law, such as when the stored data is non-anonymized medical data.

The data stored at storage device(s) 105 can be injected into an artificial recurrent neural network 110. Artificial neural networks are devices that are inspired by the structure and functional aspects of networks of biological neurons but are implemented in hardware, in software, or in combinations thereof. In particular, artificial neural networks mimic the information encoding and other processing capabilities of networks of biological neurons using a system of interconnected constructs called nodes. The arrangement and strength of connections between nodes in an artificial neural network determines the results of information processing or information storage by the artificial neural network.

Neural networks can be trained to produce a desired signal flow within the network and achieve desired information processing or information storage results. In general, training a neural network will change the arrangement and/or strength of connections between nodes during a learning phase. A neural network can be considered trained when sufficiently appropriate processing results are achieved by the neural network for given sets of inputs.

Artificial neural networks can be used in a variety of different devices to perform non-linear data processing and analysis. Non-linear data processing does not satisfy the superposition principle, i.e., the variables that are to be determined cannot be written as a linear sum of independent components.

In recurrent artificial neural networks, the connections between nodes form a directed graph along a temporal sequence and the network exhibits temporal dynamic behavior.

The data stored at storage device(s) 105 can be input into recurrent artificial neural network 110 in a variety of different ways. In general, a user may be able to uniquely specify the ways in which data stored at storage device(s) 105 is injected into a particular network to provide a level of security against undesired access. For example, recurrent artificial neural network 110 need not be constrained to receiving input over a well-defined input layer. Rather, in some implementations, a user can specify that data stored at storage device(s) 105 is to be injected into specific nodes or links that are distributed throughout network 110. As another example, recurrent artificial neural network 110 need not be constrained to receiving input in a known, previously defined manner (e.g., always injecting a first bit into a first node, the second bit into a second node, . . . etc.) Instead, a user can specify that certain bits in the data stored at storage device(s) 105 are to be injected into synapses rather than neurons, that the order of injection need not follow the order that the bits appear, or combinations of these and other parameters.

In some implementations, the data stored at storage device(s) 105 can be input into a recurrent artificial neural network 110 that has been tailored using one or more settings 115 that tailor the response of network 110 to input. These settings can, e.g., create or remove nodes or links within network 110 and/or change the properties of individual nodes or links within network 110. For example, the settings can change the strength and/or directionality of links within network 110. As another example, the settings can change the accumulation of signals or the firing threshold in a node that operates in accordance with an integrate-and-fire model. The nature of these changes can be sufficient to tailor the responsiveness of network 110 to input in a way that is hidden from, e.g., other parties who may have access to network 110 but not to settings 115. As such, settings 115 can be considered a “private key” that—along with the unchanged properties of network 110—determines the encoding the data stored at storage device(s) 105. For didactic purposes, settings 115 are schematically represented as a key in FIG. 1.

In response to the input of the data stored at storage device(s) 105, recurrent artificial neural network 110 responds with patterns of activity. The topological patterns that arise in this activity can be “read” as a neuro-topological code 120. In more detail, a neuro-topological code 120 can represent the topological features that correspond to patterns of activity that arise in a neural network when presented with a given input. In other words, the neural network can be represented as a graph. A graph is a set of nodes and a set of edges between those nodes. The nodes can correspond to, e.g., artificial neurons in a neural network. Edges can correspond to some relation between the nodes. Examples of relations include, e.g., a structural connection or activity along the connection. In the context of a neural network, artificial neurons can be related by a structural connection between neurons or by transmission of information along a structural connection. Edges can thus characterize relatively transient “activity” characteristics that occur within a defined time frame.

Neuro-topological code 120 can represent the presence or absence of topological features in the activity using a series of binary bits. The features whose presence or absence is indicated by bits in neuro-topological code 120 can be activity in, e.g., a node, a set of nodes, a set of sets of nodes, a set of edges, a set of sets of edges, and/or additional hierarchically-more-complex features (e.g., a set of sets of sets of nodes). Bits in neuro-topological code 120 generally represent the presence or absence of features that are at different hierarchical levels. For example, a first bit may represent the presence or absence of activity at a set of five nodes, whereas a second bit may represent the presence or absence of activity at a set of eight nodes. In some implementations, bits may represent the presence or absence of multi-dimension simplex patterns of activity in a graph that represents the activity.

In some implementations, the format of the neuro-topological code 120 can be tailored by a user. For example, in the order of the bits can be selected by a user.

In some implementations, the bits in neuro-topological code 120 may represent information regarding the features in a graph other than the mere presence or absence of those features. For example, bits may represent that the features have are not only present but also have a threshold level of some characteristic. For example, bits can represent not only that there is simplex pattern of activity in a set of edges, but also that this activity is either above or below a threshold level of activity.

In a reductive sense, the data from storage device(s) 105 that is input into neural network 110 is plain text and the responsive neuro topological code 120 homomorphically encrypts that plaintext.

Neuro-topological code 120 can be stored in one or more data storage devices 125. In general, data storage device(s) 125 differ from data storage devices 105. For example, data storage device(s) 125 may be a cloud data store or a longitudinal data base that is accessible to parties other than the entity or entities who own the data stored on data storage devices 105. This accessibility is indicated schematically in the figure by the unlocked sigil on data storage device(s) 125.

The entities who have access may access the data stored on data storage device(s) 125 to perform one or more data analyses 130, 135, 140. The results of data analys(es) 130, 135, 140 on neuro-topological code 120 can yield results that, when decrypted, match the results of comparable operations performed on the corresponding data stored on data storage device(s) 125. Examples of suitable data analyses include linear and non-linear statistical analysis, as well as deep learning and other AI-based techniques. These results can be achieved without providing the entities with unrestricted access to the data stored on data storage device(s) 125.

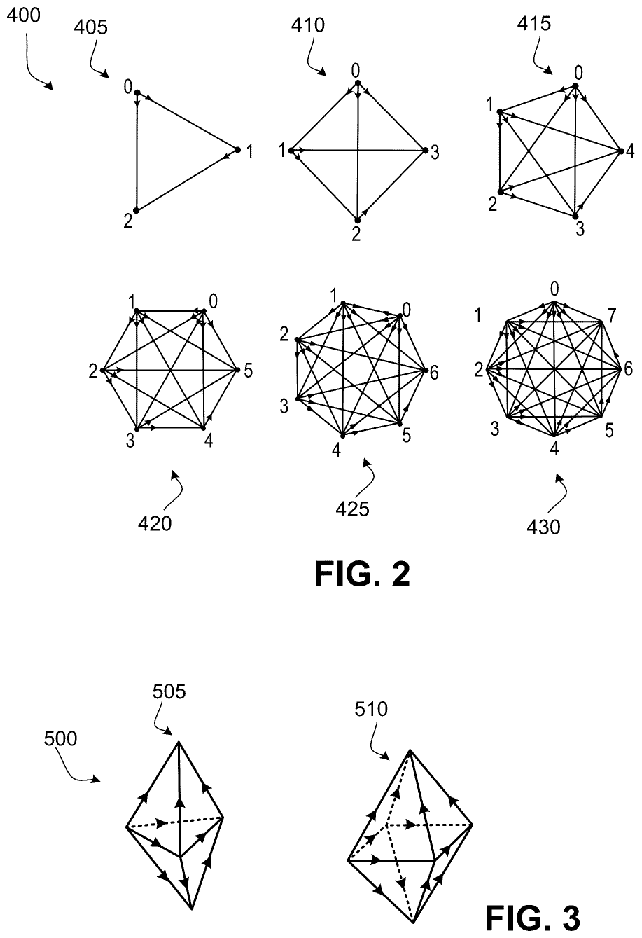

FIG. 2 is a representation of patterns 400 of activity that can be identified and “read” to generate neuro-topological code 120 from neural network 110 (FIG. 1).

Patterns 400 are representations of activity within a recurrent artificial neural network. To read patterns 400, a functional graph is treated as a topological space with nodes as points. Activity in nodes and links that comports with patterns 400 can be recognized as ordered regardless of the identity of the particular nodes and/or links that participate in the activity. In the illustrated implementation, patterns 400 are all directed cliques or directed simplices. In such patterns, activity originates from a source node that transmits signals to every other node in the pattern. In patterns 400, such source nodes are designated as point 0 whereas the other nodes are designated as points 1, 2, . . . . Further, in directed cliques or simplices, one of the nodes acts a sink and receives signals transmitted from every other node in the pattern. In patterns 400, such sink nodes are designated as the highest numbered point in the pattern. For example, in pattern 405, the sink node is designated as point 2. In pattern 410, the sink node is designated as point 3. In pattern 415, the sink node is designated as point 3, and so on. The activity represented by patterns 400 is thus ordered in a distinguishable manner.

Each of patterns 400 has a different number of points and reflects ordered activity in a different number of nodes. For example, pattern 405 is a 2D-simplex and reflects activity in three nodes, pattern 410 is a 3D-simplex and reflects activity in four nodes, and so on. As the number of points in a pattern increases, so does the degree of ordering and the complexity of the activity. For example, for a large collection of nodes that have a certain level of random activity within a window, some of that activity may comport with pattern 405 out of happenstance. However, it is progressively more unlikely that random activity will comport with the respective of patterns 410, 415, 420 . . . . The presence of activity that comports with pattern 430 is thus indicative of a relatively higher degree of ordering and complexity in the activity that the presence of activity that comports with pattern 405.

Different duration windows can be defined for different determinations of the complexity of activity. For example, when activity that comports with pattern 430 is to be identified, longer duration windows can be used than when activity that comports with pattern 405 is to be identified.

FIG. 3 is a representation of patterns 500 of activity that can be identified and “read” to generate neuro-topological code 120 from neural network 110 (FIG. 1).

Patterns 500 are groups of directed cliques or directed simplices of the same dimension (i.e., have the same number of points) that define patterns involving more points than the individual cliques or simplices and enclose cavities within the group of directed simplices.

By way of example, pattern 505 includes six different three point, 2-dimensions patterns 405 that together define a homology class of degree two, whereas pattern 510 includes eight different three point, 2-dimensions patterns 405 that together define a second homology class of degree two. Each of the three point, 2-dimensions patterns 405 in patterns 505, 510 can be thought of as enclosing a respective cavity. The nth Betti number associated with a directed graph provides a count of such homology classes within a topological representation.

The activity represented by patterns such as patterns 500 represents a relatively high degree of ordering of the activity within a network that is unlikely to arise by random happenstance. Patterns 500 can be used to characterize the complexity of that activity.

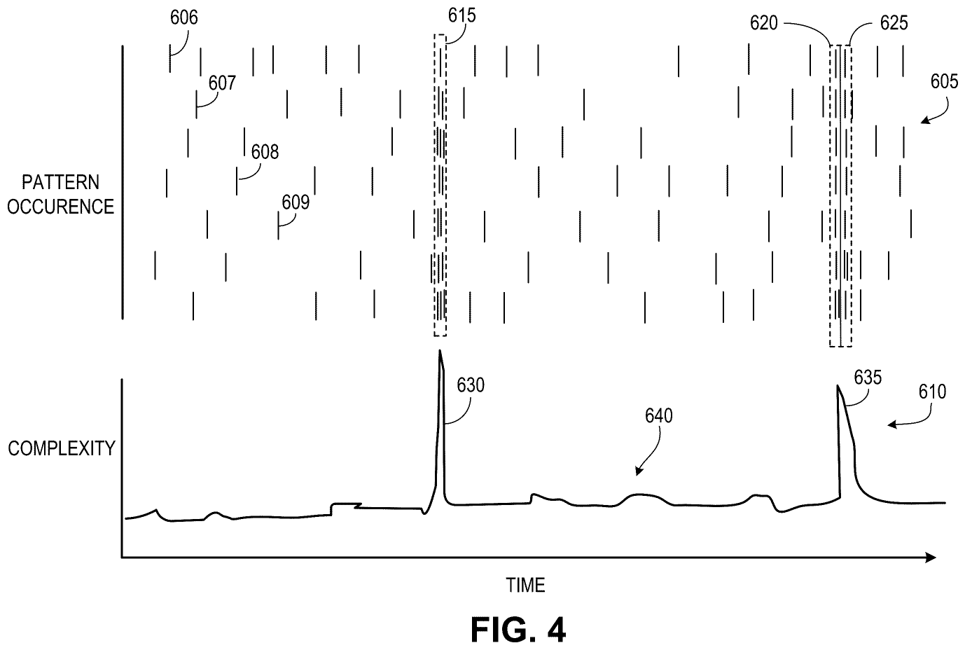

In some implementations, only some patterns of activity are identified and/or some portion of the patterns of activity that are identified are discarded or otherwise ignored during the identification of decision moments. For example, with reference to FIG. 2, activity that comports with the five point, 4-dimensional simplex pattern 415 inherently includes activity that comports with the four point, 3-dimensional and three point, 2-dimension simplex patterns 410, 405. For example, points 0, 2, 3, 4 and points 1, 2, 3, 4 in 4-dimensional simplex pattern 415 of FIG. 4 both comport with 3-dimensional simplex pattern 410. In some implementations, patterns that include fewer points—and hence are of a lower dimension—can be discarded or otherwise ignored during the identification of decision moments.

As another example, only some patterns of activity need be identified. For example, in some implementations only patterns with odd number of points (3, 5, 7, . . . ) or even numbers of dimensions (2, 4, 6, . . . ) are identified.

FIG. 4 is a schematic representation of a determination of the timing of activity patterns that have a distinguishable complexity. The determination represented in FIG. 4 can be performed as part of an identification or “reading” of patterns of activity to generate neuro-topological code 120 from neural network 110 (FIG. 1).

FIG. 4 includes a graph 605 and a graph 610. Graph 605 represents occurrences of patterns as a function of time along the x-axis. In particular, individual occurrences are represented schematically as vertical lines 606, 607, 608, 609. Each row of occurrences can be instances where activity matches a respective pattern or class of pattern. For example, the top row of occurrences can be instances where activity matches pattern 405 (FIG. 2), the second row of occurrences can be instances where activity matches pattern 410 (FIG. 2), the third row of occurrences can be instances where activity matches pattern 415 (FIG. 2), and so on.

Graph 605 also includes dashed rectangles 615, 620, 625 that schematically delineate different windows of time when the activity patterns have a distinguishable complexity. As shown, the likelihood that activity in the recurrent artificial neural network matches a pattern indicative of complexity is higher during the windows delineated by dashed rectangles 615, 620, 625 than outside those windows.

Graph 610 represents the complexity associated with these occurrences as a function of time along the x-axis. Graph 610 includes a first peak 630 in complexity that coincides with the window delineated by dashed rectangle 615 and a second peak 635 in complexity that coincides with the window delineated by dashed rectangles 620, 625. As shown, the complexity represented by peaks 630, 625 is distinguishable from what can be considered to be a baseline level 640 of complexity.

In some implementations, the times at which the output of a recurrent artificial neural network is to be read coincide with the occurrences of activity patterns that have a distinguishable complexity. For example, in the illustrative context of FIG. 4, the output of a recurrent artificial neural network can be read at peaks 630, 625, i.e., during the windows delineated by dashed rectangles 615, 620, 625.

In some implementations, not only the timing but also the content of the output of the recurrent artificial neural network is given by the activity patterns that have a distinguishable complexity. In particular, the identity and activity of the nodes that participate in activity that comports with the activity patterns can be considered the output of the recurrent artificial neural network. The identified activity patterns can thus represent the result of processing by the neural network, as well as the timing when this decision is to be read.

The content of the decision can be expressed in a variety of different forms. For example, in some implementations, the content of the decision can be expressed as a binary vector of ones and zeros, where each digit indicates whether or not a corresponding pattern is active or inactive for a pre-defined group of nodes. In such implementations, the content of the decision is expressed in binary and can be compatible with traditional digital data processing infrastructure.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations have been described. Nevertheless, various modifications may be made. Accordingly, other implementations are within the scope of the following claims.

1-20. (canceled)

21. A method implemented in hardware, in software, or in a combination thereof, the method comprising:
obtaining a private key that specifies a respective configuration of a recurrent artificial neural network for homomorphic encryption of secure data, wherein the private key specifies an input configuration specifying how bits of the secure data are injected into the recurrent artificial neural network and/or a response configuration specifying how the recurrent artificial neural network responds to the secure data;
homomorphically encrypting the secure data using the recurrent artificial neural network in accordance with the private key, comprising:
processing the secure data using the recurrent artificial neural network in accordance with the private key; and
outputting ciphertext for the secure data, wherein the ciphertext for the secure data comprises binary output data that represents whether signal transmission activity between nodes in the recurrent artificial neural network comports with one or more patterns of signal transmission activity responsive to the processing of the secure data.

22. The method of claim 21, wherein the private key comprises one or more parameters specifying at least one of:
synapses, nodes, or links into which bits of the secure data are injected, or
an order in which bits of the secure data are injected.

23. The method of claim 21, wherein the private key comprises one or more parameters specifying at least one of:
creation or removal of a node or a link in the recurrent artificial neural network, or
changing one or more properties of a node or a link in the recurrent artificial neural network.

24. The method of claim 23, wherein changing one or more properties of a node or a link in the recurrent artificial neural network comprises changing a strength or directionality of a link within the recurrent artificial neural network.

25. The method of claim 23, wherein changing one or more properties of a node or a link in the recurrent artificial neural network comprises changing an accumulation of signals or a firing threshold in a node of the recurrent artificial neural network.

26. The method of claim 21, wherein the private key specifies a mapping between respective bit positions of the ciphertext and respective patterns of signal transmission activity.

27. The method of claim 26, further comprising decrypting the ciphertext using the private key, comprising:
applying the private key to determine the mapping between respective bit positions of the ciphertext and respective patterns of signal transmission activity represented by the ciphertext; and
interpreting the ciphertext based on the mapping.

28. The method of claim 21, wherein the private key specifies a subset of the one or more patterns of signal transmission activity, and wherein the ciphertext includes binary output data representing whether signal transmission activity comports with the subset of the one or more patterns.

29. The method of claim 28, further comprising decrypting the ciphertext using the private key, comprising applying the private key to identify the subset of the one or more patterns of signal transmission activity represented by the ciphertext and interpreting the binary output data to determine whether signal transmission activity comports with the subset of the one or more patterns.

30. The method of claim 21, wherein the ciphertext comprises a vector of digits comprising ones and zeros, wherein each element of the vector corresponds to a respective pattern of the one or more patterns, and each non-zero element indicates that the signal transmission activity comports with the corresponding respective pattern.

31. The method of claim 21, wherein the one or more patterns comprise directed simplex patterns of signal transmission activity in the recurrent artificial neural network, and wherein the directed simplex patterns enclose cavities.

32. The method of claim 21, wherein processing the secure data comprises determining a timing of signal transmission activity having a complexity that is distinguishable from other signal transmission activity responsive to the processing of the secure data, and outputting the ciphertext based on the timing.

33. The method of claim 21, wherein obtaining the private key comprises retrieving the private key from a key store that stores a plurality of private keys associated with respective users, wherein for a same secure data input, different private keys of the plurality of private keys cause different ciphertext to be output.

34. The method of claim 21, further comprising storing the ciphertext in a data storage device accessible to one or more parties for analysis of the ciphertext, wherein the one or more parties lack access to the secure data in plaintext form.

35. A homomorphic encryption device comprising:
a recurrent artificial neural network; and
data processing apparatus configured to:
obtain a private key that specifies a respective configuration of a recurrent artificial neural network for homomorphic encryption of secure data, wherein the private key specifies an input configuration specifying how bits of the secure data are injected into the recurrent artificial neural network and/or a response configuration specifying how the recurrent artificial neural network responds to the secure data;
homomorphically encrypt the secure data using the recurrent artificial neural network in accordance with the private key, comprising:
processing the secure data using the recurrent artificial neural network in accordance with the private key; and
outputting ciphertext for the secure data, wherein the ciphertext for the secure data comprises binary output data that represents whether signal transmission activity between nodes in the recurrent artificial neural network comports with one or more patterns of signal transmission activity responsive to the processing of the secure data.

36. A server system comprising:
one or more processors; and
one or more memories storing instructions that, when executed by the one or more processors, cause the server system to:
receive ciphertext comprising binary output data generated as a homomorphic encryption of secure data using a recurrent artificial neural network configured according to a private key, wherein the private key specifies an input configuration specifying how bits of the secure data are injected into the recurrent artificial neural network and/or a response configuration specifying how the recurrent artificial neural network responds to the secure data, the binary output data representing whether signal transmission activity between nodes in the recurrent artificial neural network comports with one or more patterns of signal transmission activity responsive to processing of the secure data using the recurrent artificial neural network; and
process the ciphertext using one or more statistical analysis operations to output an analysis result that draws conclusions about the secure data.

37. The server system of claim 36, wherein the instructions cause the server system to process the ciphertext by executing a trained machine learning model using the ciphertext as an input feature vector.

38. The server system of claim 36, wherein the analysis result comprises a classification result, a probability score, or a regression output.

39. The server system of claim 36, wherein the server system processes the ciphertext without access to the secure data in plaintext form, and stores the analysis result in association with an identifier corresponding to the secure data.

40. The server system of claim 36, wherein the binary output data comprises a vector of digits comprising ones and zeros, wherein each element of the vector corresponds to a respective pattern of the one or more patterns, and each non-zero element indicates that the signal transmission activity comports with the corresponding respective pattern.
